(19) United States
(12) Patent Application Publication
(10) Pub. No.: US 2009/0154896 A1
(43) Pub. Date: Jun. 18, 2009

(54) Video-Audio Recording Apparatus and Video-Audio Reproducing Apparatus

(75) Inventor: Haruki MATONO, Fujisawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: HITACHI, LTD., Tokyo (JP)

(21) Appl. No.: 12/335,244

(22) Filed: Dec. 15, 2008

(30) Foreign Application Priority Data
Dec. 17, 2007 (JP) 2007-324179

(51) Int. Cl. H04N 5/91

(52) U.S. Cl. 386/96; 386/106; 386/E09.011; 386/E09.005

(57) ABSTRACT

An apparatus capable of reproducing or recording sounds with high reality sensation, including, for example, an image pickup unit for picking up an image and outputting a video signal representing a video image picked up, a sound acquisition unit supplied with sounds as an input to output an audio signal representing the input sound, a recording unit for recording the video signal output from the image pickup unit and the audio signal output from the sound acquisition unit, an object detector for detecting a location of a specific subject from the video signal, a sound extractor for extracting a sound corresponding to the detected specific subject from the audio signal, and a sound signal processor for adjusting a signal of the sound extracted by the sound extractor, on the basis of the location of the specific subject detected by the object detector.

### INCORPORATION BY REFERENCE

The present application claims priority from Japanese application JP2007-324179 filed on Dec. 17, 2007, the content of which is hereby incorporated by reference into this application.

### BACKGROUND OF THE INVENTION

The present invention relates to a video-audio recording apparatus and a video-audio reproducing apparatus.

As for background arts in this technical field, for example, JP-A-2006-287544 and JP-A-2007-5849 can be mentioned.

In JP-A-2006-287544, a problem is described to be “making directivity or the directive angle in recorded audio signals of a plurality of channels variable when reproducing a recorded video signal at an arbitrary angle of view.” As for means for solving the problem, there is description “a recording device 105 for recording audio signals of n channels supplied from n (where n is an integer of at least 2) microphone units 101 and a video signal supplied from a video camera 103 on a recording medium, a reproducing device 106 for reproducing the audio signals of the n channels and the video signal recorded on the recording medium, a video manipulation input unit 113 for selecting a specific angle of view of a reproduced image based on the video signal reproduced by the reproducing device 106, and an audio computation processing unit 107 for conducting computation processing to control the directive angle or directivity of the audio signals of the n channels reproduced by the reproducing device 106, on the basis of a video signal corresponding to the selected angle of view are provided.”

As for a problem of the invention disclosed in JP-A-2007-5849, there is description “the present invention relates to a recording apparatus, a recording method, a reproducing apparatus, a reproducing method, a program of the recording method, and a recording medium having the program of the recording method recorded thereon. The present invention is applied to, for example, a video camera using an optical disc of DVD. Even when an individual user records multi-channel audio signals by using a video camera or the like, the present invention makes it possible to enjoy multi-channel audio signals with high reality sensation as compared with the conventional art.” As for means for solving the problem, there is description “in the present invention, characteristics of multi-channel audio signals FRT, FL, FR, RL, RR and LF are varied so as to correspond to a video of a video signal obtained as a result of image pickup.

As other background arts, for example, US 2006/0291816, JP-A-2004-147205 and JP-A-2001-169309 can also be mentioned.

In US 2006/0291816, a problem is described to be “making it possible to emphasize a sound issued from a specific subject in an image picked up.” As for means for solving the problem, there is description “an image recognition unit 131 generates a histogram of pixels which constitute an image, makes a match between the histogram and a pattern of a histogram of pixels obtained when a person is taken in the image, and outputs a correlation coefficient. A decision unit 132 makes a decision whether there is a person in the image on the basis of the correlation coefficient. If a person is judged to be in the image, then a directivity manipulation unit 133 sets a polar pattern with importance attached to the front direction, and an audio band manipulation unit 134 conducts processing on audio signals so as to emphasize the frequency band of human voices. The present invention can be applied to video cameras.”

In JP-A-2004-147205, a problem is described to be “providing an image-sound recording apparatus which makes stereophonic recording of sounds possible and is capable of recording a moving picture with reality sensation.” As for means for solving the problem, there is description “an image-sound recording apparatus 10 picks up an image of a subject field and forms an image signal 103 which represents the subject field. Furthermore, the image-sound recording apparatus 10 collects sounds of the left side and the right side of the subject field, and forms a left sound signal 108 and a right sound signal 110. In addition, the image-sound recording apparatus 10 detects a motion vector from the image signal 103 by conducting signal processing, and judges the most powerful moving direction in the image on the basis of the motion vector. The image-sound recording apparatus 10 adjusts the left sound signal 108 and the right sound signal 110 so as to change the balance between the left sound volume and the right sound volume according to the moving direction, stereo-records these sound signals to emphasize the moving sensation in sounds, and implements moving picture recording with reality sensation.”

As for a problem, there is description in JP-A-2001-169309 “in the conventional information recording apparatus and information reproducing apparatus, sound information and image information are recorded linearly or in a plane form without having information concerning the accurate location such as depths of sound sources and a subject. The reality sensation, the cubic effect and convenience of information cannot be obtained sufficiently, when reproducing information.” As for means for solving the problem, there is description “information concerning the location of sound sources and the subject is recorded in addition to sound information and image information. When reproducing those kinds of information, the added information concerning the location is utilized effectively. For example, in the case of sound information, location information is added to each of recording tracks respectively associated with musical instruments and at the time of reproduction tracks are provided respectively with different propagation characteristics to form a sound field with depth.

### SUMMARY OF THE INVENTION

In aforementioned JP-A-2006-287544, a sense of incompatibility between the image and sounds is reduced by conducting manipulation such as changing the angle of view and thereby changing the directivity of sounds when reproducing a video. However, sounds become wanting in stereophonic sensation by providing the sounds with directivities.

In aforementioned JP-A-2007-5849, image pickup with higher reality sensation is made possible by adjusting directivities and frequency characteristics according to the image pickup mode or the like. However, it is difficult to enhance the reality sensation by only conducting adjustment according to the image pickup mode and image pickup condition.

In aforementioned US 2006/0291816, a polar pattern with importance attached to the front direction is set and the frequency band of human voices is emphasized when a person is judged to be in the image. However, only importance is attached to the front direction, and the left and right directions are not mentioned.

In aforementioned JP-A-2004-147205, the most powerful moving direction in the image is judged on the basis of the motion vector. The balance between the left sound volume and the right sound volume is changed according to the moving direction, and moving picture recording with reality sensation is implemented. Since sound volumes of the collected left and right sounds are changed as they are, however, even a sound of a subject which is not originally moving moves.

In aforementioned JP-A-2001-169309, microphones are prepared respectively for sound sources. The collected sounds are recorded together with location information. At the time of reproducing, tracks are provided respectively with different propagation characteristics to form a sound field with depth. However, as many microphones as the number of the sound sources are needed.

At least enhancement of the reality sensation obtained by detecting a location of a specific subject from a video signal, extracting a sound of the specific subject from an audio signal and adjusting the extracted sound on the basis of the detected location is not described in any of foregoing technical papers.

Therefore, the reality sensation is enhanced by, for example, detecting a location of a specific subject from a video signal, extracting a sound of the specific subject from an audio signal and adjusting the extracted sound on the basis of the detected location. Furthermore, the ratio of distribution of voice components to the left and right can be changed on the basis of a result of speaker detection including whether there is a speaker and a location on the screen by, for example, providing speaker detection as object detection. If a person is present on the right side of the screen, then human voice components among audio data acquired from microphones are distributed more to the right side channel and recorded. Or, for example, a speaker detection result which is information representing in which location on the screen a person is present is recorded on a recording medium together with video-audio information, and at the time of reproducing, audio data is adjusted on the basis of the speaker detection result. To be more precise, configurations prescribed in claims are provided.

According to the present invention, the reality sensation can be enhanced. Even if a subject is away from microphones and image pickup with stereophonic sensation using the microphones is difficult, location of a person on the screen picked up is detected by synergism of detection of a location of a specific subject from a video signal and extraction of a sound of a specific subject, and voice of the person is adjusted to the left and right according to the location. Image pickup with stereophonic sensation becomes possible.

Problems, configurations and effects other than those described above are made clear by the ensuing description of the embodiments.

### BRIEF DESCRIPTION OF THE DRAWINGS

FIG. 1 is a diagram showing a data flow at the time of recording in a first embodiment;

FIG. 2 is a diagram showing a data flow at the time of reproducing in a second embodiment;

FIG. 3 is a diagram for explaining speaker detection in the first embodiment;

FIG. 4 is a diagram showing details of a sound signal processor (at the time of recording) in the first embodiment;

FIG. 5 is a diagram showing a configuration example of a recording-reproducing apparatus in the first embodiment;

FIG. 6 is a diagram showing details of a sound signal processor (at the time of reproducing) in the second embodiment; and

FIG. 7 is a diagram showing a data flow at the time of recording in a third embodiment.

### DESCRIPTION OF THE INVENTION

Hereafter, embodiments of the present invention will be described with reference to the drawings.

### First Embodiment

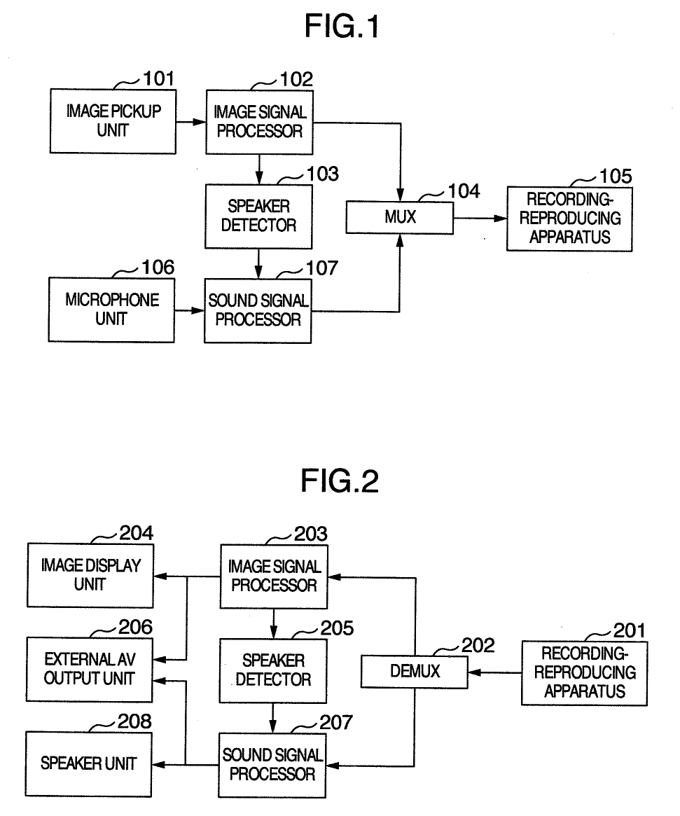

FIG. 1 is a diagram showing a configuration example of a video camera as an example of a video-audio recording apparatus which records video-audio data (also referred to as video data and audio data). FIG. 1 represents a flow mainly concerning the recording. However, the present invention is not restricted to video cameras.

First, a video input will now be described. An image pickup unit 101 is a unit for receiving light incident from a lens unit which can zoom, by using an image pickup element such as a CMOS or CCD and converting a resultant signal to digital data pixel by pixel.

An image signal processor 102 is supplied with an output of the image pickup unit 101 as its input. The image signal processor 102 conducts image processing such as tint adjustment, noise reduction and edge enhancement.

A speaker detector 103 which is an example of an object detector detects whether a speaker which is an example of a specific subject is present and finds a location of the speaker, on the basis of a video which is input from the image signal processor 102.

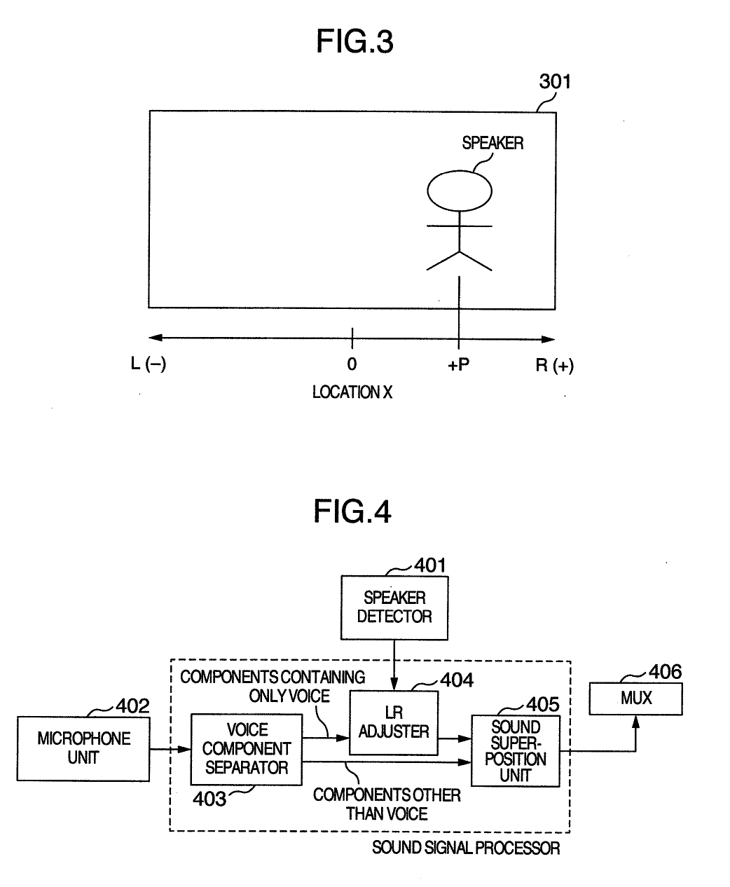

FIG. 3 is a diagram showing a location of a speaker in an image pickup range 301. An abscissa axis (location X) represents on which of the left and right sides of the screen the speaker is present. For the sake of convenience, the location is defined to be positive (+) when the speaker is on the R (right) side, whereas the location is defined to be negative (−) when the speaker is on the L (left) side. For example, in the case of a composition shown in FIG. 3, the location of the speaker is output as “+P.” As for a method for identifying the speaker location, there is a technique of detecting a face and detecting a motion of lips. However, the present invention is not restricted to this. If a plurality of persons are present in the image pickup range 301, locations of respective persons are detected. In addition, a motion of lips is detected to also detect which speaker is speaking.

Audio input will now be described. A microphone unit 106 shown in FIG. 1 includes two microphones mounted on the left and right sides thereof to acquire left and right sounds. The microphone unit 106 is a unit for converting audio signals to electric signals, conducting analog-to-digital conversion by using AD converters, and outputting obtained results.

A sound signal processor 107 is supplied with an output of the microphone unit 106 as its input. The sound signal processor 107 can adjust left and right audio signals.

FIG. 4 shows a configuration example of the sound signal processor 107. A speaker detector 401 and a microphone unit 402 shown in FIG. 4 correspond to the speaker detector 103 and the microphone unit 106 shown in FIG. 1, respectively. A voice component separator 403 is supplied with an output of the microphone unit 402 as its input. The voice component separator 403 separates audio data into human voice components and components other than the human voice components. As for a human voice separation-method, there is, for example, a method of extracting a frequency in the range of 400 Hz to 4 kHz. However, the present invention is not restricted to this method. The human voice components are input to an LR adjuster 404, whereas the components other than the human voice components are input to a sound superposition unit 405. The LR adjuster 404 has a function of adjusting distribution of the human voice components to the left and right (LR) sides according to an output of the speaker detector 401. For example, the ratio of distribution of human voice to the left and right sides may be varied in proportion to the location of the speaker. The sound superposition unit 405 superposes human voice components adjusted in distribution to the left and right sides by the LR adjuster 404 and the components other than the human voice components separated by the voice component separator 403 on each other.

If there are a plurality of speakers, then the voice component separator 403 extracts sounds from directions associated with locations respectively of the speakers. And the location of each speaker and timing of voice issuing are detected on the basis of face detection and a motion of lips, and human voice components are adjusted on the basis of the location and timing. By using such a technique and superposing voices of respective persons on left and right loud speakers in the ratios corresponding to the locations of the respective persons, it becomes possible to separate voices of a plurality of persons and conduct image pickup with reality sensation. In the case where there are a plurality of persons, especially in the case where it is detected that lips of a plurality of speakers are moving simultaneously, control may be exercised to stop human voice extraction and superposition and conduct intact recording. This is useful when a plurality of persons are speaking and separation of human voice components is judged to be difficult.

If there is a distance between a camera and a subject, then human voices are recorded only from the center in the conventional art. On the other hand, according to the present embodiment, a speaker's voice is emphasized on the left or right side according to the speaker's location on the screen by the above-described serial processing. Or adjustment is conducted so as to bring a location of a person reproduced on the basis of an audio signal of human voice adjusted by the above-described serial processing close to a location of a speaker detected by the speaker detector 103. As a result, it becomes possible to pick up an image of a scene with higher reality sensation.

The present embodiment has been described supposing stereo sounds of two channels. However, multi-channel sounds such as 5.1-channel sounds may also be used. In the present embodiment, human voices are extracted and adjusted. However, musical instruments (or their players) and animals may be detected, and sound components of the musical instruments and animals may be extracted.

The degree of sound adjustment may be changed according to whether zooming is conducted. When detection is conducted with a wide angle, the camera is located relatively near the subject. Therefore, more natural stereophonic sensation is obtained by lowering the degree of adjustment. Adjustment of the audio signal tempered with image pickup parameters such as zoom magnification and an image pickup mode may be conducted.

Means for previously setting these adjustments before recording with the camera may also be provided so as to be able to set the adjustments easily. For example, three modes: a stage mode, an athletic meet mode, and a baby mode are prepared. In the case of the stage mode, the directivity of each microphone is provided in front of the camera so as not to collect sounds generated around the camera and the degree of distributing human voice components to the left and right sides is made large. By doing so, image pickup with high reality sensation becomes possible also when an image of a speaker who is comparatively far away such as a speaker on a stage is to be picked up. In the athletic meet mode, it is desired to collect sounds of cheering in the neighborhood and consequently the directivity of each microphone is made wide. Only when the subject is one person, human voice components are distributed to the left and right sides. However, the degree of the distribution to the left and right sides is made slightly weak. As a result, natural image pickup becomes possible even in situations where there are a large number of speakers and it is desired to collect respective voices. In the baby mode, baby's voice components are set so as to be especially emphasized in the process for extracting human voice components. As a result, it becomes possible to conduct image pickup with clear baby's voice. These setting examples are nothing but example, and the present invention is not restricted to them.

A MUX 104 shown in FIG. 1 conducts processing for compressing and superposing video data output from the image signal processor 102 and audio data output from the sound signal processor 107. A recording-reproducing apparatus 105 records the compressed and superposed data. For example, when recording data on a BD (Blu-ray Disc) which is a large capacity optical disc, video data is compressed by using the H.264/AVC form, audio data is compressed by using the Dolby digital form, and resultant data are superposed in the TS (Transport Stream) form and recorded. As for the recording medium, there are a DVD, a flash memory (such as an SD card), magnetic tape and a hard disc besides the BD. Alternatively, it is also possible to transfer the data to a recording apparatus in an external device via a network and record the data therein. The present invention is not restricted to these recording media.

All or a part of the processing heretofore described may be implemented on a computer. In other words, the above-described processing may be conducted by cooperation of software which causes a computer to execute all or apart of the above-described processing and the computer serving as hardware which executes the software.

In the present embodiment, an example in which audio data is directly adjusted and recorded on a recording medium has been described. Alternatively, it is also possible to record an adjustment parameter of audio data separately from the video-audio data and conduct reproduction according to the adjustment parameter at the time of reproducing.

Here, the adjustment parameter means all or a part of information required to execute the above-described processing. The adjustment parameter is information to be recorded in order to make it possible to interrupt the above-described processing on the way and finish the recording, and thereafter resume the continuation of the above-described processing at the time of reproducing.

For example, the location of a speaker detected by the speaker detector 103 is recorded as the adjustment parameter separately from the video-audio data. And at the time of reproducing, the above-described processing may be executed by using the recorded speaker location to adjust the distribution of the human voice components to the left and right (LR) sides. Or, in the operation for adjusting the distribution of human voice components to the left and right (LR) sides according to the output of the speaker detector 401 conducted by the LR adjuster 404, information representing to what degree the human voice components in audio data at which time point should be distributed to the left and right (LR) is recorded as the adjustment parameter separately from the video-audio data. And at the time of reproducing, distribution of the pertinent human voice components to the left and right (LR) sides may be adjusted according to the adjustment parameter.

It becomes possible to select whether the user applies the present effect after recording, by thus conducting the processing of distributing human voice components to the left and right (LR) sides to conduct adjustment at the time of reproducing.

### Second Embodiment

In the first embodiment, a specific subject is detected and a sound is extracted, and the left-right adjustment of the extracted sound is conducted at the time of recording. Alternatively, they may be conducted at the time of reproducing.

FIG. 2 is a diagram showing a configuration example of a video camera as an example of a video-audio reproducing apparatus which records video-audio data (also referred to as video data and audio data). FIG. 2 represents a flow which mainly concerns the reproducing. However, the present invention is not restricted to the video camera.

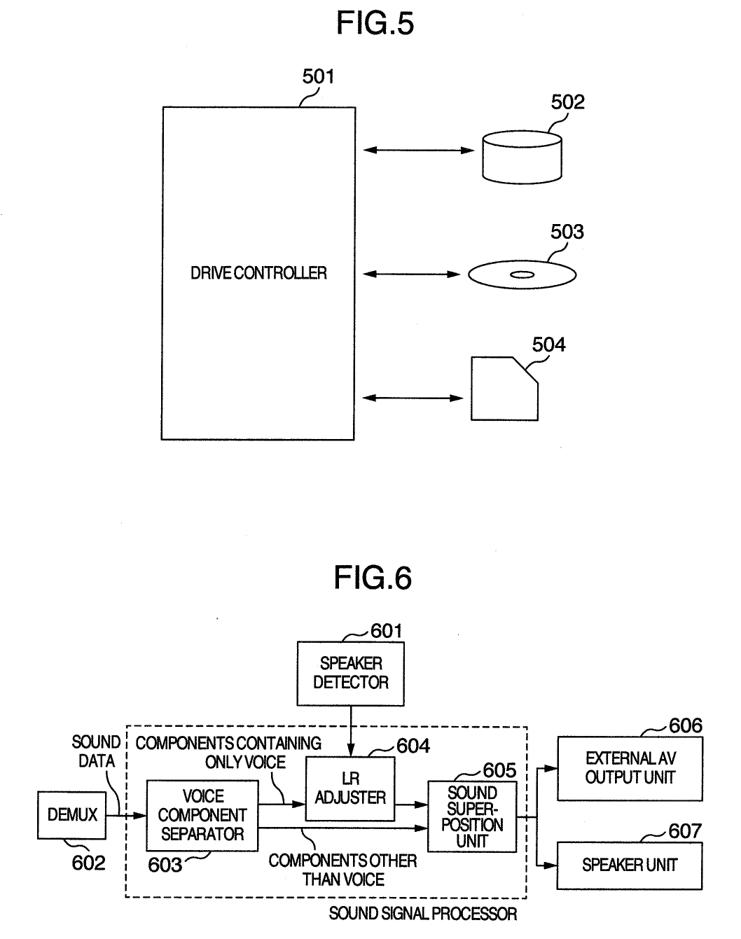

A recording-reproducing apparatus 201 conducts writing into and reading from a recording medium. At the time of reproducing, the recording-reproducing apparatus 201 reads out video-audio data from the recording medium and inputs the video-audio data to a DEMUX 202. The DEMUX 202 separates video data and audio data, conducts expansion processing on the video data and the audio data, inputs the video data to an image signal processor 203, and inputs the audio data to a sound signal processor 207. For example, when reproducing data from a BD (Blu-ray Disc) which is a large capacity optical disc, video data is compressed by using the H.264/AVC form, audio data is compressed by using the Dolby digital form, and resultant data are superposed in the TS (Transport Stream) form and recorded. As for the recording medium, there are a DVD, a flash memory (such as an SD card), magnetic tape and a hard disc besides the BD. Alternatively, it is also possible to transfer the data from an external device to a recording apparatus via a network and reproduce the data. The present invention is not restricted to these recording media. Since the image signal processor 203 and a speaker detector 205 have the same functions as those of the image signal processor 101 and the speaker detector 103 described in the first embodiment, respectively, description of them will be omitted. FIG. 5 shows a block diagram indicating a drive controller 501 to be provided within such arranged recording device 105 or recording-reproducing apparatus.

The sound signal processor 207 is supplied with an output of the DEMUX 202 as its input. The sound signal processor 207 conducts audio signal processing on the basis of a result output from the speaker detector 205.

FIG. 6 shows details of the sound signal processor 207. A speaker detector 601, a DEMUX 602, an external AV output unit 606 and a speaker unit 607 shown in FIG. 6 correspond to the speaker detector 205, the DEMUX 202, an external AV output unit 206 and a speaker unit 208 shown in FIG. 2, respectively. A voice component separator 603, an LR adjuster 604 and a sound superposition unit 605 have the same functions as those of the voice component separator 403, the LR adjuster 404 and the sound superposition unit 405 described with reference to the first embodiment and shown in FIG. 4, respectively. In other words, the location of the speaker is identified on the basis of video data read out from the recording-reproducing apparatus 201, and the distribution of voice components to the left and right sides is adjusted according to the location.

It becomes possible to reproduce a video image picked up in the past with high reality sensation by thus conducing processing of detecting a specific subject, extracting sounds and adjusting the distribution of the extracted sounds to the left and right sides, at the time of reproducing. Furthermore, since the processing is not conducted at the time of recording, it becomes possible for the user to select whether to apply the present effect after the recording.

An output of the image signal processor 203 is input to an image display unit 204 and the external AV output unit 206. On the other hand, as for the sounds, an output of the sound signal processor 207 is input to the speaker unit 208 and the external AV output unit 206. The image display unit 204 displays data supplied from the image signal processor 203 on a LCD (Liquid Crystal Display) or the like. The speaker unit 208 conducts D/A conversion on audio data input from the sound signal processor 207 to generate sounds. The external AV output unit 206 outputs video-audio data input thereto from, for example, an HDMI (High-Definition Multimedia Interface) terminal or the like. The terminal can be connected to a television set or the like.

All or a part of the processing heretofore described may be implemented on a computer. An implementation method using software and hardware has been described above.

### Third Embodiment

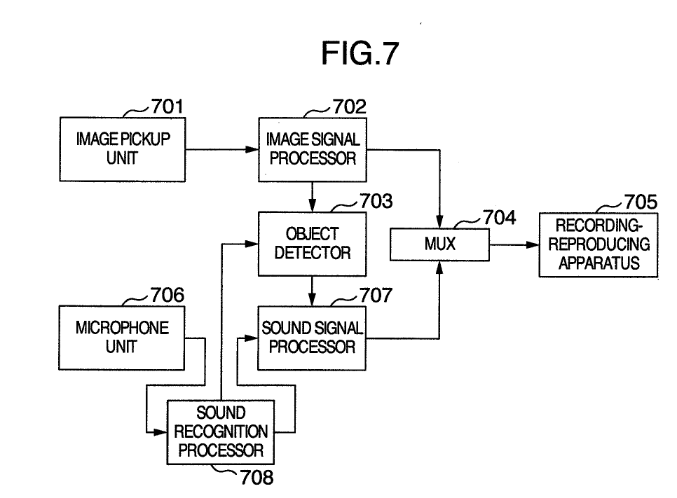

FIG. 7 is a diagram showing a configuration example of a video camera as an example of an information recording apparatus which records video-audio data (also referred to as video data and audio data). An example in which the precision of image recognition is improved by changing an operation mode of the image recognition according to a result of sound recognition will now be described. Parts equivalent to those in the first embodiment will be omitted in description. In the present embodiment as well, a video camera is taken as an example. However, the present invention is not restricted to the video camera.

In the first embodiment, the sound signal processor 1 is shown in FIG. 1. In the present embodiment, however, a sound recognition processor 708 is provided in a stage preceding a sound signal processor 707. The sound recognition processor 708 analyzes sounds, detects a sound such as a human speaking voice, a sound of a musical instrument and a sound of a vehicle, and inputs a result of the detection to an object detector 703. Audio data input from a microphone unit 706 to the sound recognition processor 708 is used for analysis and input to the sound signal processor 707 as it is.

The object detector 703 has a function of detecting an object such as a musical instrument and a vehicle besides a human speaking voice, in addition to the function of the speaker detector 103 described in the first embodiment. A detection method in the object detector 703 can be changed according to a result input from the sound recognition processor 708. For example, if it is detected from the sound recognition processor 708 that human voice is contained, then the object detector 703 conducts retrieval around human being. On the contrary, if human voice cannot be detected, wide and shallow detection of a speaker, a musical instrument, an animal or the like is conducted. If a tone of a musical instrument is detected, then a musical instrument corresponding to the tone is retrieved preferentially. By doing so, a detection range of an object is restricted on the basis of a result of the sound recognition and it becomes possible to detect a specific subject (such as, for example, an object or a person) efficiently in a restricted time.

The present invention is not restricted to the above-described embodiments, but various modifications are included. For example, the embodiments have been described in detail in order to explain the present invention intelligibly. The present invention is not necessarily restricted to configurations including all described components. Furthermore, it is possible to replace a part of a configuration of an embodiment by a configuration of another embodiment. It is also possible to add a configuration of an embodiment to a configuration of another embodiment.

The present invention can be applied to, for example, a video camera.

It should be further understood by those skilled in the art that although the foregoing description has been made on embodiments of the invention, the invention is not limited thereto and various changes and modifications may be made without departing from the spirit of the invention and the scope of the appended claims.

1. A video-audio recording apparatus comprising:
an image pickup unit for picking up an image and outputting a video signal representing a video image picked up;
a sound acquisition unit supplied with sounds as an input to output an audio signal representing the input sound;
a recording unit for recording the video signal output from the image pickup unit and the audio signal output from the sound acquisition unit;
an object detector for detecting a location of a specific subject from the video signal;
a sound extractor for extracting a sound corresponding to the detected specific subject from the audio signal; and
a sound signal processor for adjusting a signal of the sound extracted by the sound extractor, on the basis of the location of the specific subject detected by the object detector.

2. The video-audio recording apparatus according to claim 1, wherein
the object detector detects a speaker.

3. The video-audio recording apparatus according to claim 2, wherein
the sound extractor extracts components of voice of the speaker detected by the object detector, and
the sound signal processor adjusts the extracted voice of the speaker on the basis of a location of the speaker detected by the object detector.

4. The video-audio recording apparatus according to claim 1, wherein
the sound signal processor adjusts the location of the specific subject reproduced on the basis of the signal of the sound extracted by the sound extractor so as to cause the location to approach the location of the specific subject detected by the object detector.

5. The video-audio recording apparatus according to claim 4, wherein
the sound acquisition unit outputs an audio signal of a plurality of channels, and
the sound signal processor adjusts a sound volume of each of the channels of the audio signal extracted by the sound extractor, in accordance with the location of the specific subject detected by the object detector.

6. The video-audio recording apparatus according to claim 1, wherein
the object detector detects locations respectively of a plurality of the specific subjects and timing of issuance of a sound from each of the specific subjects,
the sound extractor extracts audio signals corresponding to sounds issued respectively by the specific subjects, and
the sound signal processor adjusts the audio signals extracted by the sound extractor, in accordance with the locations respectively of a plurality of specific subjects and timing of issuance of a sound from each of the specific subjects detected by the object detector.

7. The video-audio recording apparatus according to claim 6, wherein
the specific subjects are speakers, and
the object detector detects locations respectively of a plurality of speakers and timing of issuance of a voice from each of the speakers by detecting lip motions respectively of the speakers.

8. The video-audio recording apparatus according to claim 1, wherein
the image pickup unit can change zoom magnification or an image pickup mode, and
the sound signal processor changes a degree of adjustment of the audio signal on the basis of the zoom magnification or the image pickup mode in the image pickup unit.

9. The video-audio recording apparatus according to claim 1, further comprising a sound recognizer for recognizing a specific sound from the audio signal,
wherein the object detector detects a location of a specific subject corresponding to a specific sound recognized by the sound recognizer.

10. The video-audio recording apparatus according to claim 1, wherein the recording unit records the video signal output from the image pickup unit and the audio signal output from the sound acquisition unit and adjusted by the sound signal processor.

11. The video-audio recording apparatus according to claim 1, wherein
the recording unit is further capable of reproducing the video signal and the audio signal,
when recording the video signal and the audio signal, the recording unit records an object detection result which is information of the location of the specific subject detected by the object detector,
when reproducing the video signal and the audio signal, the recording unit reads out the object detection result, and
the sound signal processor adjusts the signal of the sound extracted by the sound extractor, on the basis of the object detection result read out.

12. A video-audio reproducing apparatus comprising:
a reproducing unit for reproducing a video signal and an audio signal;
an object detector for detecting a location of a specific subject from the video signal;
a sound extractor for extracting a sound corresponding to the detected specific subject from the audio signal; and
a sound signal processor for adjusting a signal of the sound extracted by the sound extractor, on the basis of the location of the specific subject detected by the object detector.

13. The video-audio reproducing apparatus according to claim 12, wherein
the object detector detects a speaker.

14. The video-audio reproducing apparatus according to claim 13, wherein
the sound extractor extracts components of voice of the speaker detected by the object detector, and
the sound signal processor adjusts the extracted voice of the speaker on the basis of a location of the speaker detected by the object detector.

15. The video-audio reproducing apparatus according to claim 12, wherein
the sound signal processor adjusts the location of the specific subject reproduced on the basis of the signal of the sound extracted by the sound extractor so as to cause the location to approach the location of the specific subject detected by the object detector.

16. The video-audio reproducing apparatus according to claim 15, wherein
the reproducing unit reproduces an audio signal of a plurality of channels, and
the sound signal processor adjusts a sound volume of each of the channels of the audio signal extracted by the audio extractor, in accordance with the location of the specific subject detected by the object detector.

17. The video-audio reproducing apparatus according to claim 12, wherein
the object detector detects locations respectively of a plurality of the specific subjects and timing of issuance of a sound from each of the specific subjects,
the sound extractor extracts audio signals corresponding to sounds issued respectively by the specific subjects, and
the sound signal processor adjusts the audio signals extracted by the sound extractor, in accordance with the locations respectively of a plurality of specific subjects and timing of issuance of a sound from each of the specific subjects detected by the object detector.

18. The video-audio reproducing apparatus according to claim 17, wherein
the specific subjects are speakers, and
the object detector detects locations respectively of a plurality of speakers and timing of issuance of a voice from each of the speakers by detecting lip motions respectively of the speakers.

19. The video-audio reproducing apparatus according to claim 11, further comprising a sound recognizer for recognizing a specific sound from the audio signal,
wherein the object detector detects a location of a specific subject corresponding to a specific sound recognized by the sound recognizer.
